(19) United States
(12) Patent Application Publication
(10) Pub. No.: US 2013/0109518 A1
(43) Pub. Date: May 2, 2013

(54) HYDRAULIC TENSIONER

(71) Applicant: Tsubakimoto Chain Co., Osaka (JP)

(72) Inventors: Yuji Kurematsu, Osaka (JP); Osamu Yoshida, Osaka (JP)

(73) Assignee: TSUBAKIMOTO CHAIN CO., Osaka (JP)

(21) Appl. No.: 13/661,199

(22) Filed: Oct. 26, 2012

(30) Foreign Application Priority Data
Oct. 31, 2011 (JP) 2011-238599

(51) Int. Cl. F16H 7/08

(52) U.S. Cl. 474/110

(57) ABSTRACT

In the check valve of a hydraulic tensioner, the cap wall of a check ball retainer has a stroke restricting surface that restricts movement of the check ball from a valve seat. The stroke restricting surface is a concave surface having a curved cross-sectional shape. The center of curvature of the curve is located on the side of the stroke restricting surface on which the ball seating surface of the check valve is located, and is either radially inward from the a point of abutment between the check ball and the stroke restricting surface or substantially on the center line of the valve seat.

### CROSS REFERENCE TO RELATED APPLICATIONS

The disclosure of Japanese Patent Application No. 2011-238599, filed on Oct. 31, 2011 is incorporated by reference in its entirety.

### FIELD OF THE INVENTION

The invention relates to a hydraulic tensioner for applying tension to traveling transmission chain, and more specifically to improvements in a check valve in the tensioner.

### BACKGROUND OF THE INVENTION

A hydraulic tensioner typically includes a housing, a plunger protruding from the housing for applying tension to a chain, and a check valve that allows oil to flow into an oil chamber formed by the housing and the plunger while restricting flow of oil out of the oil chamber.

The check valve includes a ball seat having an oil passage, a check ball that opens the oil passage by separating from the ball seat and closes the oil passage by engaging the ball seat, and a retainer that restricts the movement of the check ball. The typical check valve, however, has no spring for biasing the check ball against the seat, such as disclosed in laid-open Japanese Patent Application No. 2008-89100.

When the check ball separates from the ball seat, the check ball can move in a disorderly manner due to the flow of oil resulting from the difference between the hydraulic pressure in the oil supply passage leading to the check valve and the hydraulic pressure in the oil chamber. When the check ball-biasing spring is not present, the disorderly movement of the check ball can delay the opening of the check valve, and cause a variation in the rate of flow of oil from the oil passage to the oil chamber. This phenomenon can bring about deterioration in the performance of the tensioner by degrading the damping effect of the oil in the oil chamber and by causing variations in the rapidity with which the tensioner applies tension to the chain.

The gap between the retainer and the check ball, when seated on the ball seat, can be reduced to suppress the disorderly movement of the check ball that occurs when no valve spring is used. However reduction of this gap, hampers the flow of oil within the retainer, and the performance of the tensioner deteriorates because of the reduced oil flow rate. In particular, the reduction of the gap impairs rapid application of tension to the chain. On the other hand, if the number of oil ports provided in the retainer is increased, the rigidity of the retainer, and its durability, are reduced.

When the check valve is provided with a valve spring, the ball stroke distance, i.e., the distance through which the check ball can move, is also restricted by the cap wall of the retainer. The valve spring also imposes limitations on the size and shape of the retainer because it limits the range of allowable stroke distances. Furthermore, the shape of the stroke restricting surface is limited because of the need to avoid adhesion of the valve spring to the retainer.

In the case of a tensioner having a check valve not provided with a member for biasing the check ball, there is a need to improve the rapidity of valve closure operation, to stabilize the rate of flow of oil into the oil chamber, and to provide a greater degree of freedom in setting the stroke restricting surface while suppressing disorderly movement of the check ball.

### SUMMARY OF THE INVENTION

The hydraulic tensioner according to the invention comprises a housing having an oil supply passage, a plunger slidable in a plunger accommodating hole in the housing and protruding from housing for applying tension to an endless, flexible transmission medium, an oil chamber formed by the housing and the plunger, and a check valve for permitting oil to flow from the oil supply passage into the oil chamber but limiting the flow of oil from the oil chamber to the oil supply passage. The check valve comprises a ball seat having a valve oil passage for flow of oil between the oil supply passage and the oil chamber and a seating surface symmetrical about a center line, a check ball arranged to seat on the seating surface to close the valve oil passage and to separate from the seating surface to open the valve oil passage, and a retainer, arranged to be abutted by the check ball, for restricting the distance through which the check ball can separate from the seating surface. The check ball is capable of seating on the seating surface and of separating from the seating surface and abutting the retainer, in response solely to a difference between the hydraulic pressures in the valve oil passage and the hydraulic pressure in the oil chamber.

The retainer has a cap wall facing the check ball along the direction of the center line. The cap wall has a stroke restricting surface for abutment by the check ball, that restricts the distance through which check ball can move away from the seating surface in the direction of said center line. The stroke restricting surface is a concave surface having curved cross-sections in section planes containing the center line. The retainer limits the abutment points at which the check ball can abut the stroke-restricting surface to an abutment region on the stroke-restricting surface. The center of curvature of the curve at each abutment point within the abutment region is located on the same side of the stroke-restricting surface on which the seating surface of the ball seat is located, and the radial distance from any abutment point in the abutment region, except for a set of abutment points in proximity to the center line, is greater than the distance from the center of curvature of the curve to the center line.

Preferably, the radial distance from any abutment point in the abutment region, except for a set of abutment points within a distance from the center line equal to 10% of the radius of the check ball, is greater than the distance from the center of curvature to the center line.

The check valve has no biasing spring or other valve biasing member, urging the check ball in the valve closing direction, so the check ball opens and closes the valve in response only to the hydraulic pressure differential across the valve seat. A line normal to the curve of the stroke restricting surface at an abutment point extends in a direction either such that, as it approaches the center of curvature, it becomes closer to the center line, or it extends substantially along the center line. Consequently, the reaction force exerted on the check ball by the stroke restricting surface always acts in a direction either toward or along the center line. Accordingly, radial outward movement of the check ball is suppressed, and disorderly movement of the check ball is avoided.

Consequently, the rapidity with which the check ball can close the valve is improved, and the damping performance of the tensioner, and stabilization of the flow rate of oil into the oil chamber are improved by reducing variations in the flow rate of oil flowing from the oil passages into to the oil chamber. Thus, it is possible to improve stability of the tensioner's performance in applying tension to a flexible traveling transmission medium such as an endless transmission chain.

In addition, Because there is no valve-biasing spring or other biasing member in the retainer, a broader range is available for the shape of the stroke restricting surface and for setting the stroke distance of the check ball. Even though the shape of the stroke restricting surface and the stroke distance can vary widely, disorderly movement of the check ball can be avoided.

The retainer has a circumferential wall centered on the center line and provided with a plurality of oil feed ports disposed at equal circumferential intervals; the circumferential wall has an inner circumferential surface the radial dimensions of which are such that, when the check ball is seated on the seating surface, a radial gap centered on the center line is formed between the check ball and the circumferential wall.

In one embodiment, the inner circumferential surface includes a base surface and a plurality of local concave surfaces. Each of the local concave surfaces is disposed between a pair of oil feed ports and has a radial dimension greater than the radius of the base surface. The base surface is capable of being abutted by the check ball when the check ball is separated from the seating surface whereby the base surface restricts radial movement of the check ball. When the check ball abuts the base surface on each side of one of the local concave surfaces, the check ball, with that local concave surface, forms an oil passage through which oil can flow through the retainer past the ball in a direction parallel to the center line.

The hydraulic pressure of the oil flowing through the oil passage suppresses movement of the check ball in the radially outward direction, and thereby suppresses disorderly movement of the check ball.

Friction between the check ball and the inner circumferential surface of the retainer is also reduced, smoothing the movement of the check ball and improving closing and opening of the check valve, even when the rate of flow of the oil between the oil passage and the oil chamber is low.

The oil passages also prevent the check ball from hindering the flow of oil within the retainer, ensuring the required flow rate of the oil from the oil passage to the oil chamber without reducing he rigidity of the retainer or impairing the durability of the retainer. The oil passages formed between the check ball and the concave surfaces increase the oil flow rate through the check valve.

In another embodiment, the inner circumferential surface has a base surface and a plurality of local surfaces. Each local surface is disposed between a pair of oil feed ports and has a radial dimension less than the radius of the base surface. Each of the local surfaces is capable of being abutted by the check ball when the check ball is separated from the seating surface whereby the local surfaces restrict radial movement of the check ball. The base surface and the local surfaces are shaped so that, when the check ball is in abutment with two local surfaces on opposite sides of a portion of the base surface between those two local surfaces, the check ball, with that portion of the base surface, forms an oil passage through which oil can flow through the retainer past the ball in a direction parallel to the center line.

With this arrangement, radial movement of the check ball is restricted by the local surfaces and movement of the check ball is limited to a range of positions close to the center line so that disorderly movement of the check ball is suppressed.

The inward force exerted on the check ball by the hydraulic pressure of the oil flowing through the oil passages also suppresses disorderly movement of the check ball. Furthermore, the reduction of friction between the check ball and the inner circumferential surface of the retainer is reduced, so that the check ball can move more smoothly, and closing and opening of the valve are improved even when the rate of flow of oil between the oil passage and the oil chamber is low.

The check ball is prevented from hindering flow of oil within the retainer and ensures the required rate of flow of oil from the oil passage to the oil chamber without reducing the rigidity of the retainer or reducing its durability.

Another aspect of the invention is the retention of the ball seat by the retainer, the engagement of the retainer with the housing and the prevention of movement of the retainer in the radial direction. The hooks that engage with the housing both prevent the retainer from separating from the housing, and position the retainer in a fixed radial position with respect to the housing, making it possible to improve the assembly and removal of the retainer.

Because the ball seat is retained integrally with the retainer, the check valve can be attached to, and removed from, the housing as a module, thereby improving and facilitating assembly and disassembly of the tensioner.

Furthermore, because it is possible to set the positional relationship between the retainer and the ball seat before the check valve is inserted into the housing, it is possible to establish the positional relationship between the seating surface and the stroke restricting surface with greater precision.

### BRIEF DESCRIPTION OF DRAWINGS

FIG. 1 is a schematic front elevational view of a timing chain transmission having a hydraulic tensioner according to the invention;

FIG. 2A is a cross-sectional view of the tensioner;

FIG. 2B is an enlarged view of a part of the tensioner corresponding to a section taken on section plane 2A-2A in FIG. 4;

FIG. 3 is a perspective view of a check valve of the tensioner:

FIG. 4A is a cross-sectional view taken on section plane 4A-4A in FIG. 2B;

FIG. 4B is an enlarged view of a part of the check valve shown in FIG. 4A;

FIG. 4C is an enlarged sectional view of the check valve taken on section plane 4C-4C in FIG. 4A;

FIG. 5 is a cross-sectional view, of a part of a modified hydraulic tensioner in accordance with the invention, corresponding to FIG. 4A and taken on section plane 5-5 in FIG. 6A;

FIG. 6A is a cross-sectional view taken on section plane 6A-6A in FIG. 5; and

FIG. 6B is an enlarged view of a part of the tensioner shown in FIG. 6A.

### DETAILED DESCRIPTION OF THE PREFERRED EMBODIMENTS

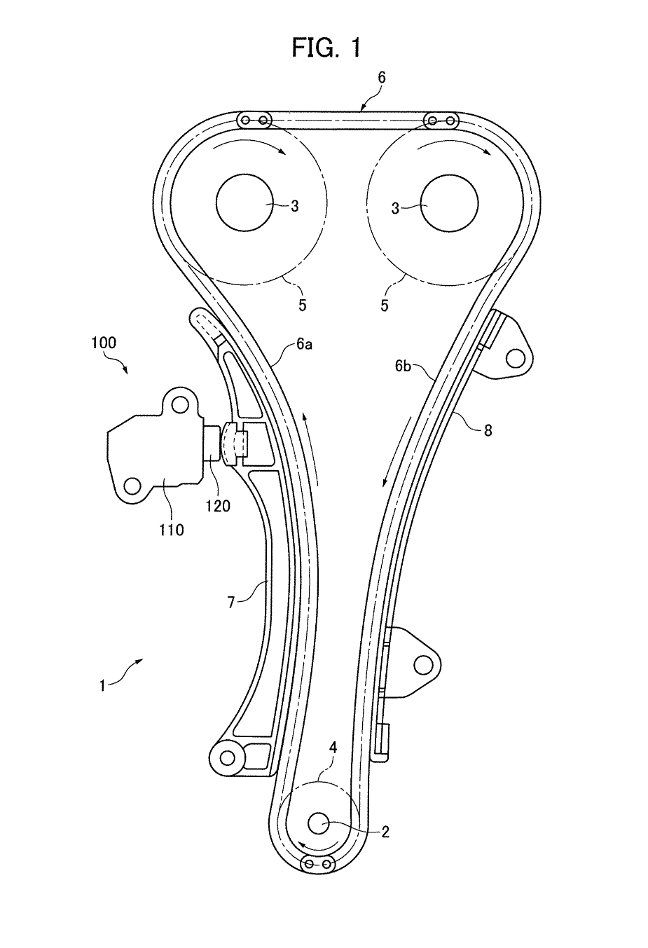

As shown in FIG. 1, a tensioner 100 is provided in a timing chain transmission 1 of a dual overhead cam (DOHC) internal combustion engine (not shown), for example, an automobile engine. The timing chain transmission comprises a sprocket 4 driven by a crankshaft 2, a pair of camshaft sprockets 5 fixed on camshafts 3, and an endless timing chain 6 in mesh with sprockets 4 and 5.

The housing 110 of tensioner 100 is attached to an engine block (not shown) adjacent the slack side 6a of the chain, i.e., the span of the chain that travels from the crankshaft sprocket toward the camshaft sprockets.

A hollow plunger 120 that protrudes from within the tensioner housing 110 presses against a pivoted lever 7 on which the slack side the slack side 6a of the chain slides, and thereby regulates the tension in the chain by protruding from, and retracting into, the tensioner housing.

A stationary guide 8 for is attached to the engine block in a position to guide the tension side 6b of the chain, i.e., the span that travels from the camshaft sprockets 5 toward the crankshaft sprocket 4.

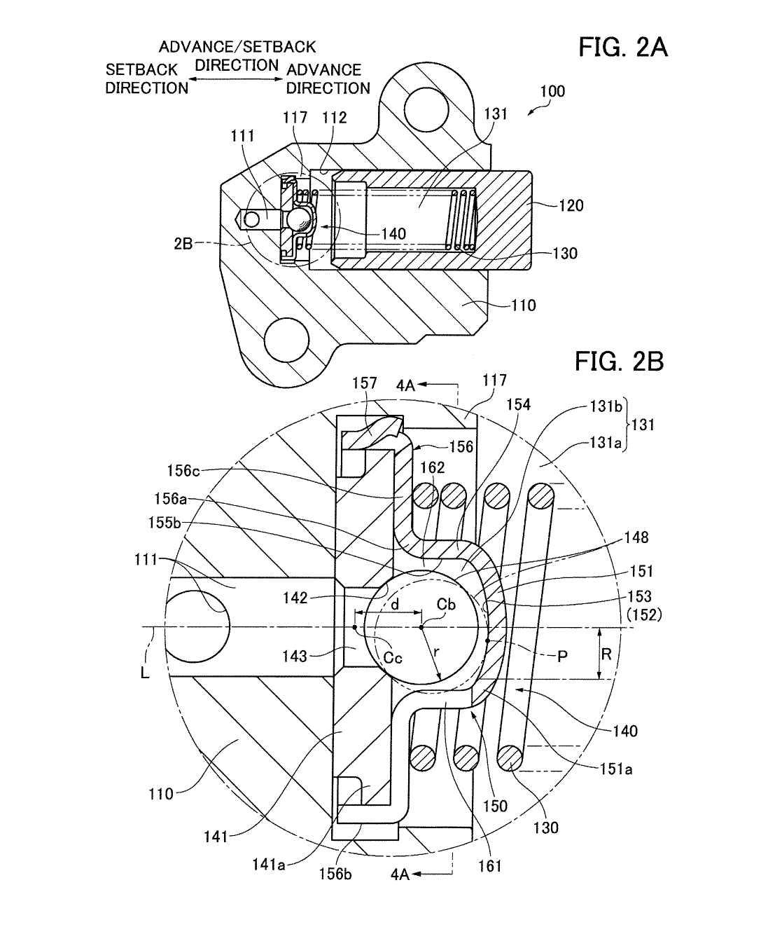

As shown in FIG. 2A, the housing 110 of tensioner 100 is provided with an oil supply passage ill for feeding oil supplied from the engine block into a plunger-accommodating hole 112 in the tensioner housing. A plunger-biasing spring 130, disposed within the plunger accommodating hole 112 and within an oil chamber 131 formed by the housing 110 and the hollow space within the plunger 120, bias the plunger 120 in the protruding direction. A check valve 140 permits oil to flow from the oil supply passage 111 into the oil chamber 131, while preventing oil from flowing out of the oil chamber 131 to the oil supply passage 111.

Both the plunger-biasing spring 130 and the oil in the oil chamber 131 constitute a plunger-biasing means for biasing the plunger 120 in the protruding direction.

Oil fed from outside the tensioners to the oil chamber 131 through the oil supply passage 111 is supplied by an oil pump (not shown) in the engine. The oil pump of course operates while the engine is running and is inoperative when the engine is stopped.

As shown in FIG. 2B, the check valve 140 includes an annular ball seat 141 provided with an oil passage 143 to which the oil supply passage 111 is connected, and a spherical check ball 148 that opens and closes the oil passage 143 by separating from and seating on a seating surface 142 of the ball seat 141. The check valve also includes a retainer 150 that surrounds the ball seat 141 and the check ball 148. The retainer can engage the check ball, and thereby restrict movement of the check ball, when the check ball separates from the seat.

The seating surface 142 on is a tapered surface of revolution, symmetrical about an axial center line L of the oil passage 143.

The check ball 148 is capable of seating on and separating from the seating surface 142, and abutting the retainer 150, in response to differences between the hydraulic pressure in the oil passage 143 and the hydraulic pressure in oil chamber 131. Accordingly, the opening and closing forces acting on the check ball 148 correspond to the hydraulic pressure differential between the oil passage 143 and the oil chamber 131. When the hydraulic pressure in the oil chamber 131 becomes greater than the hydraulic pressure in the oil passage 143, oil flows from the oil chamber 131 to the oil passage 143, and the check ball 148 seats on the seating surface 142, closing the oil passage 143 and preventing oil from continuing to flow out to the oil passage 143 from the oil chamber 131.

The check valve 140 is not provided with a valve-biasing member, e.g., a valve spring, for biasing the check ball 148 in a direction to close the valve.

As shown also in FIGS. 2, 3 and 4A-4C, the retainer 150 of the check valve 140 has a cap wall 151 facing the check ball 148 in the direction of center line L. A circumferential wall 154 meets an outer circumferential portion 151a of the cap wall 151 and surrounds the check ball 148. The retainer also includes a flange 156, which has an inner circumferential portion 156a meeting the circumferential wall 154 at an end thereof remote from the cap wall 151.

The term “center line direction” refers to a direction parallel to the center line L. “Radial” and “circumferential” directions are directions centered on center line L. Radially “inner” and “outer” directions are radial directions toward and away from the center line L respectively.

The cap wall 151 has a stroke restricting surface 152, that restricts the distance through which the check ball 148 can move from its seated condition in the center line direction. This stroke restricting surface 152 is a concave surface the cross-sectional shape of which, in any plane including the center line L, is a curve 153 as shown in FIG. 2B.

When the check ball 148 separates from the seat, its movement is determined by the flow of oil resulting from the difference between the hydraulic pressures in oil passage 143 and the hydraulic pressure in oil chamber 131 within the retainer 150. As illustrated in FIG. 2B, the movement of the ball 148 is illustrated by a broken line. The movement of the ball is restricted by an abutment region in the stroke restricting surface 152 within which the ball contacts the stroke restricting surface at an abutment point P, and by the inner surface 155 of the circumferential wall 154 of the retainer.

The contact region within which a check ball can contact the stroke restricting surface 152 of the retainer at an abutment point is such that all possible abutment points are within a radius R from the center line L. This radius R larger than the radius of the outermost portion of the annular seating surface 142 that is contacted by the check ball when the check valve is closed. It is then possible to use the same retainer 150 with different check balls in a range of sizes, which can move radially by different amounts when separated from the valve seat. When the radius R of the stroke restricting surface is larger than the radius of the outermost portion of the seating surface the resulting versatility of the retainer enables the costs of these check valves to be reduced.

The center of curvature Cc of the curve 153 is located on the same side of the stroke restricting surface 152 on which the seating surface 142 is located, and is substantially on the center line L. The term “substantially” as used herein is intended to include not only the specific element, relationship or parameter described, but also a range of variations thereon in which there is no significant difference in the relevant operations and effects. Here, the center of curvature Cc will be closer than most possible abutment points P to the center line L. Thus, a line normal to the curve 153 at any abutment point will either extend inward toward the center line L, when proceeding from the abutment point toward the center of curvature Cc, or will substantially coincide with the center line. The term “substantially coincide with the center line” means that the maximum distance from the normal line from the center line L is within 10% of the radius r of the check ball 148.

In the embodiment shown in FIG. 2B, the stroke restricting surface 152 is spherical and the curve 153 is a circular arc centered on center of curvature Cc substantially on center line L.

The radius of curvature of the stroke restricting surface 152 is larger than the radius r of the check ball 148. The distance d from the center of curvature Cc to the center Cb of the seated check ball 148 can within the range r≦d≦1.5r or within the range 0≦d≦2r. In FIG. 2B, the distance d is in the range r≦d≦1.5r.

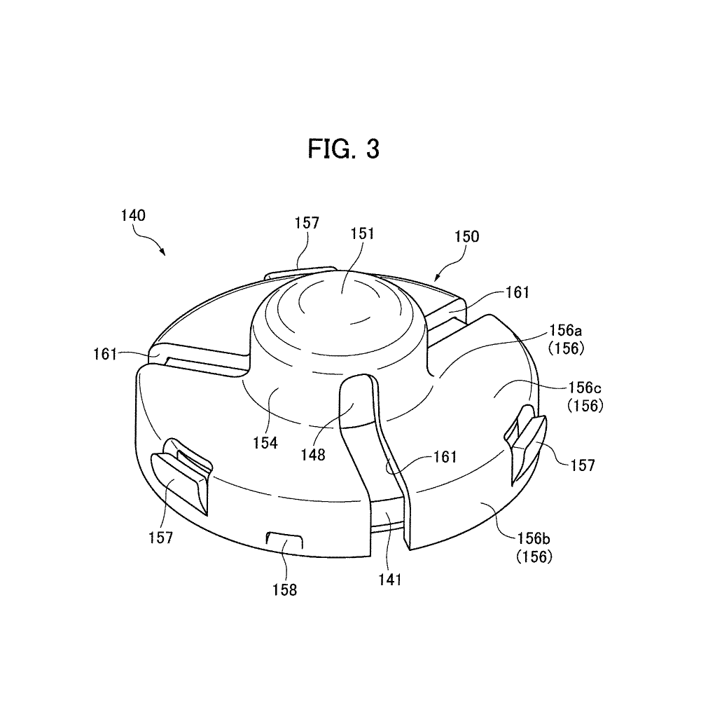

A plurality (three in the embodiment shown in FIG. 3) of oil feed ports 161 is provided in the retainer. These oil feed ports are disposed at equal intervals around the circumference of the retainer and extend from the circumferential wall 154 to the flange 156.

As shown in FIG. 2B, each oil feed port 161 is composed of a slot that enables oil to flow between an oil chamber 131b within the retainer 150 and an outer oil chamber 131a outside the retainer 150. The inner and outer oil chambers 131b and 131a are both part of oil chamber 131 in FIG. 2A.

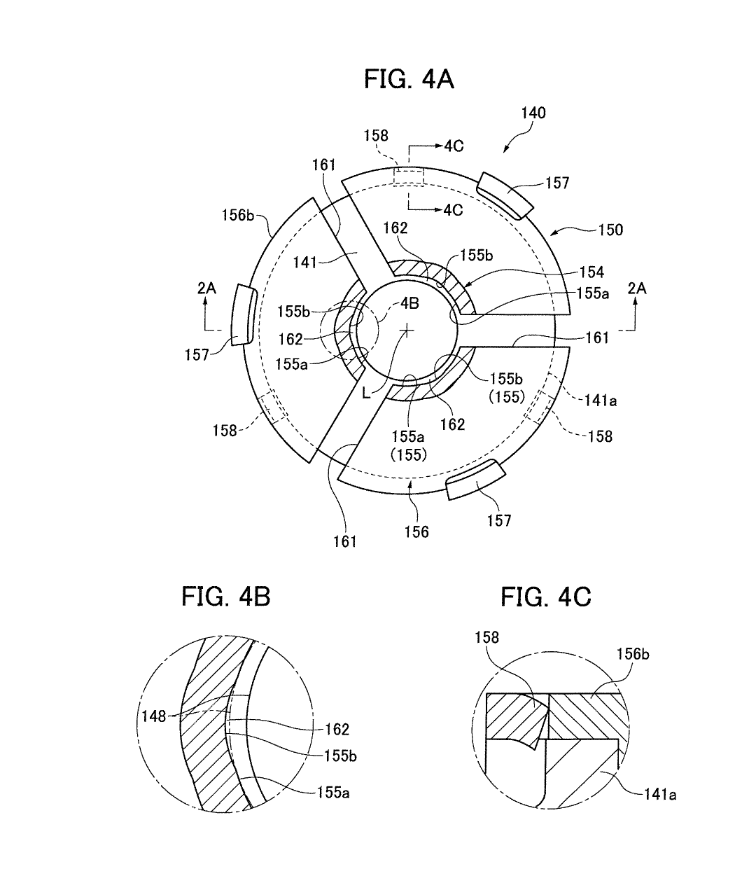

As shown in FIGS. 2B and 4A, a radial gap is formed between the inner circumferential surface 155 of the wall 154 and the seated check ball 148. This gap is centered on the center line L. As shown in FIGS. 4A and 4B, the inner circumferential surface 155 has a base surface 155a composed of components centered on center line L, and a plurality of local concave surfaces 155b disposed between the oil feed ports 161 at equal circumferential intervals. These concave surfaces extend radially outward from the base surface 155a. By abutting the check ball 148, the base surface 155a restricts radial movement of the check ball 148 when the check ball is separated from the seat. The concave surfaces form oil passages 162, within the oil chamber 131b, for the flow of oil within the retainer 150 between the check ball 148 (indicated by a broken line in FIG. 4B) that abuts the base surface 155a on both sides of the local concave surface 155b. That is, the oil feed passage 162 is formed by the local concave surface 155b, the base surface 155a and the check ball 148.

As shown in FIG. 2B, the flange 156 has an inner circumferential portion 156a, an outer circumferential portion 156b and an intermediate portion 156c between the inner circumferential portion and the outer circumferential portion 156b. The outer circumferential portion 156b of flange 156 surrounds the ball seat 141.

As shown in FIGS. 2B, 3, 4A, and 4C, the outer circumferential portion 156b of the flange has a plurality of engagement hooks 157 that project radially outward, and a plurality of retaining hooks 158 that protrude radially inward. The outwardly protruding engagement hooks 157 engage the tensioner housing, while the inwardly projecting hooks engage the ball seat 141. In the embodiment depicted in these figures, there are three outwardly protruding hooks and three inwardly projecting hooks. The intermediate portion 156c of the retainer is abutted by the plunger-biasing spring 130 as shown in FIG. 2B.

The three outwardly protruding hooks 157 engage radially stepped inward-protruding surfaces on parts 117 of the housing 110 and both hold the retainer in the housing and hold the retainer in a predetermined radial position.

The three inwardly protruding retaining hooks 158 are disposed at equal intervals in the circumferential direction, between the outwardly protruding engaging hooks 157. These inwardly protruding hooks 158 abut the outer circumferential portion 141a of a ball seat 141. Each of the retaining hooks 158 is preferably disposed midway between two engaging hooks.

The ball seat 141 is held between the intermediate portion 156c of the retainer and the retaining hooks 158. The ball seat is prevented from being pulled out of the retainer 150 by the retaining hooks 158, and is held in a predetermined radial position by engagement with the outer circumferential portion 156b of the retainer.

Because the ball seat 141 is integrated with the retainer 150 as described above, the check valve 140 is in the form of a module comprising the ball seat 141, the check ball 148, and the retainer 150.

When the hydraulic pressure in the oil passage 143 becomes larger than the hydraulic pressure in the oil chamber 131, the check ball 148 separates from the seating surface 142. Then, as oil flows from the oil supply passage 111 into the oil chamber 131 through the oil passage 143, the plunger 120, biased by the plunger-biasing spring 130 and by oil pressure in oil chamber 131, advances and applies tension to the chain 6 through the movable lever 7 as shown in FIG. 1. Thus, the check ball 148 opens the valve when the tension in the chain 6 decreases, and the plunger 120 advances to apply tension to the chain 6.

On the other hand, when the tension in the chain 6 increases, the force applied by the chain to the plunger through lever 7 increases, and the plunger 120 is pressed in the retracting direction against the biasing forces applied by the plunger-biasing spring 130 and the pressure of the oil of the oil chamber 131. The hydraulic pressure in oil chamber 131 rises, and the check ball 148 seats on seating surface 142 and closes the valve, when the hydraulic pressure in the oil chamber 131 exceeds the hydraulic pressure in the oil passage 143.

When the valve is closed by the check ball, oil remaining within the oil chamber 131, exerts a damping function, preventing excessive decrease in the tension in the chain 6.

The opening of the check valve allows tension to be applied quickly to the chain by the flow of oil from the oil passage 143 to the oil chamber 131.

In the check valve 140, the check ball 148 is capable of seating on, and separating from, the seating surface 142 and of abutting the retainer 150, depending on the difference between the hydraulic pressures in the oil passage 143 and the hydraulic pressure in the oil chamber 131. The stroke-restricting surface 152 of the retainer cap wall 151 limits the stroke of the check ball 148 from its seated condition to its separated condition along the direction of the center line L.

As mentioned previously, the center of curvature Cc of the curve at the abutment point P is located toward the ball seating surface with respect to the stroke restricting surface 152, and, depending on the location of the abutment point, the center of curvature Cc is located either closer than the abutment point P to the center line L, or substantially on the center line L and substantially aligned with the abutment point. A line normal to the curve at the abutment point either becomes closer to the center line L as it extends from the stroke restricting surface 152, or extends substantially along the center line.

Because the check valve 140 has no valve spring or other valve biasing member that biases the check ball 148 in the valve closing direction, the check ball 148 moves only in response to the difference between the hydraulic pressures in the oil passage 143, which is connected to the oil supply passage 111, and the hydraulic pressure in oil chamber 131, and abuts the stroke restricting surface 152 when it is separated from the seat.

In the case of a conventional stroke-restricting surface in a plane orthogonal to the center line of a check valve, because of the above-described concave configuration of the stroke restricting surface 152, the reaction force exerted on the check ball 148 by the stroke restricting surface 152 is directed toward the center line L. Accordingly, radial outward movement of the check ball 148, in a direction away from the center line L, is reduced and, thus suppressing the disorderly movement of the check ball 148, improving the rapidity with which the check ball 148 closes the check valve. The above-described configuration of the stroke-restricting surface also enhances the stability of the performance of the tensioners by stabilizing the rate of oil flow to the oil chamber 131 by reducing variation of the flow rate of oil flowing from the oil passages 162 and 163 to the oil chamber 131.

The elimination of the valve biasing member also increases the range of possible shapes of the stroke restricting surface and the range of possible distances of the stroke restricting surface from the check ball, while at the same time preventing disorderly movement of the check ball.

The oil feed ports 161 are provided at uniform intervals in the circumferential wall 154, and between each adjacent pair of oil feed ports the inner surface 155 of the wall is formed with concave surfaces 155b that extend radially outward relative to the base surface 155a. These concave surface 155b are also located at uniform intervals, each being located between a pair of oil feed ports. The base surface 155b restricts radial movement of the check ball 148 when the ball is separated from the seat by abutting the check ball. When the check ball abuts the base surface 155a on both sides of a concave surface 155b, the concave surface, in cooperation with the check ball, forms an oil passages 162 through which oil can flow within the retainer 150 in the direction of the center line. The hydraulic pressure of oil flowing through the oil passages 162 suppresses radial outward movement of the check ball, thereby further reducing disorderly movement of the check ball, reducing friction between the check ball and the inner circumferential surface 155 and smoothing the movement of the check ball, thereby improving closing and opening valve even when a rate of flow of oil between the oil passage 143 and the oil chamber 131 is small.

By forming the oil passages 162 in such a way as to ensure the required flow rate of oil flowing from the oil passage 143 to the oil chamber 131, it is possible to prevent the flow of oil within the retainer from being hindered by the check ball without reducing the rigidity of the retainer or impairing its durability, of the retainer 150. It is even possible to form the local concave surfaces 155b so that the oil flow rate through passages 162 is increased.

The engaging hooks 157 that hold the retainer 150 in the housing 110 and fix the retainer against radial translation, facilitate assembly of the check valve and the housing, and also make it easy to remove the check valve from the housing. Moreover, the use of retaining hooks 158 for holding the ball seat 141 integrally with the retainer 150, make it possible to attach the check valve to the housing, and remove it from the housing, as a single module, thereby facilitating assembly and disassembly of the tensioners.

Because it is possible to set the positional relationship between the retainer 150 and the ball seat 141 before the check valve 140 is inserted into the housing 110, the positional relationship between the seating surface 142 and the stroke restricting surface 152 can be set with high precision so that the stroke-restricting surface can more effectively suppress disorderly movement of the check ball.

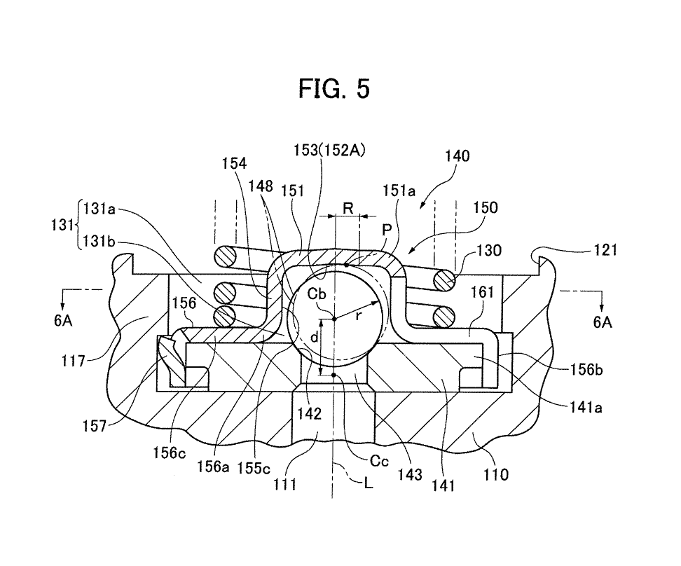

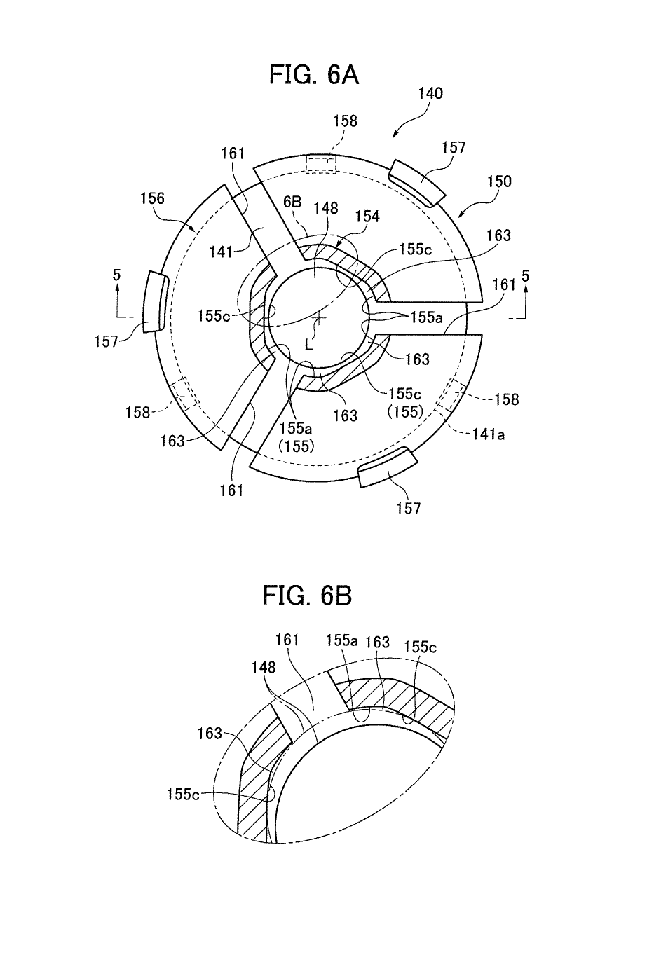

In a modification illustrated in FIGS. 5, 6A and 6B, parts corresponding to parts in the previously described embodiment are designated by the same reference numerals.

In the case of FIG. 5, the radial movement of the ball is limited by local surfaces 155c of the wall 154 of the retainer, which are disposed radially inward from the base surface 155a of the wall. Here, in contrast with the previously described embodiment, the radius R, which defines the range of distances from possible abutment points P on the stroke restricting surface 152A to the center line L, is smaller than the smallest diameter of the portion of the seating surface 142 contacted by ball 148.

The local surfaces 155c are uniformly spaced from one another in the circumferential direction so that the inner circumferential surface 155 of wall 154 includes the base surface 155a in the form of parts of a circular cylinder having center line L as its axis and local surfaces 155c, which are in the form of planes to which center line L is parallel. The oil feed ports 161 extend through the parts of the base surface of wall 154 midway between the local surfaces 155c.

In this embodiment, as shown in FIG. 6B, the ball (shown by a broken line in FIG. 6B when in abutment with the wall 154) abuts the local portions 155c of the wall at two points. As a result, two oil passages 163 are formed between the check ball 148 and the base surface 155a of the wall on both sides of the oil feed port 161. Each oil passage 163 is open to the oil feed port 161.

In this embodiment, radial movement of the check ball 148 is restricted by the local surfaces 155c which are disposed radially inward from the base surface 155a, so that the check ball 148 maintained closer to the center line L than it would be if the circumferential surface 155 of the retainer were composed only of the base surface 155a having a uniform radius.

The hydraulic pressure of oil flowing through the oil passages 163 exerts a radial inward force on the check ball 148, suppressing disorderly movement of the check ball and at the same time reducing friction between the check ball and the inner circumferential surface 155 of the wall 154. Thus it is possible to smooth the movement of the check ball 148, and to improve the closing and opening of the valve even when the rate of flow of oil between the oil passage 143 and the oil chamber 131 is low.

By forming the oil passage 163 so that it is open to the oil feed port 161 It is possible to prevent the check ball from hindering the flow of oil within the retainer 150 and to ensure the required oil flow rate without reducing the rigidity of the retainer or impairing its durability.

The same effects as described above can be achieved using retainers with stroke restricting surfaces having curvatures different from those of the embodiments described above. For example, the curve 153 of the stroke restricting surfaces 152 or 152A can be a clothoid curve having its center of curvature Cc substantially on the center line L. The curve 153 can also be a complex curve composed of a plurality of curves of different types, having different radii and different centers of curvature. The complex curve can include straight line components, and the stroke restricting surfaces 152 and 152A can even contain planar components.

It is also possible to permit a limited amount of oil to flow out of the oil chamber 131 when the check valve is closed by the check ball in order achieve a desired degree of damping.

The plurality of local concave surfaces 155b or the plurality of local surfaces 155c can be provided at equal or unequal different intervals in the circumferential direction. Each of the oil feed ports can be composed of a group of openings such as a plurality of holes instead of a slot.

The hydraulic tensioner of this invention can be utilized not only with chain transmissions, but also with other kinds of transmissions having endless flexible transmission media such as belt transmissions, and can be used in various kinds of machinery other than engines.

What is claimed is:

1. A hydraulic tensioner, comprising:
a housing provided with an oil supply passage;
a plunger provided within the housing movably in advance and set back directions to apply a tension to a wrap-around transmission;
an oil chamber formed by the housing and the plunger; and
a check valve that limits the flow of pressure oil under pressure out of the oil chamber to the oil supply passage while permitting oil to flow into the oil chamber from the oil supply passage;
the check valve including;
a ball seat provided with an oil passage that communicates the oil supply passage with the oil chamber;
a check ball that opens and closes the oil passage by separating from and seating on a seating surface of the ball seat; and
a retainer that is disposed separately from the check ball when the check ball is seated on the ball seat to restrict the distance by which the check ball can separate from the seat by abutting the check ball;
wherein:
the check ball is configured to be capable of seating on and separating from the seating surface and of abutting the retainer in response only to a difference of hydraulic pressures in the oil passage and in the oil chamber;
the retainer has a cap wall facing the check ball in a direction parallel to a center line of the seating surface;
the cap wall has a stroke restricting surface that restricts the stroke of the check ball when the check ball separates from the seat in the direction of said center line;
the stroke restricting surface is a concave surface whose cross-sectional shape in a plane including said center line is a curve; and
when an abutment region of the stroke restricting surface with the check ball is an abutment point, the center of curvature of the curve at the abutment point is located on a side on which the seating surface is located with respect to the stroke restricting surface in the direction of said center line and either radially inward from the abutment point or substantially on the center line, or a normal line of the curve at the abutment point extends in the radially inward direction as the normal line heads to the seating surface from the stroke restricting surface in the center line direction or extends substantially on the center line.

2. The hydraulic tensioner according to claim 1, wherein the radial distance from any point in said abutment region, except for a set of points within a distance from said center line equal to 10% of the radius of said check ball, is greater than the distance from said center of curvature to said center line.

3. The hydraulic tensioner according to claim 1, wherein the retainer has a circumferential wall provided with a plurality of oil feed ports at equal intervals in the circumferential direction centering on the center line;
the circumferential wall has an inner circumferential surface that forms a gap in the radial direction centering on the center line between the check ball seating on the seat;
the inner circumferential surface has a base surface and a plurality of local concave surfaces disposed respectively between the oil feed ports neighboring with each other in the circumferential direction and located in the radially outward direction more than the base surface;
the base surface is a radial restricting surface that restricts a radial moving distance of the check ball separated from the seat by abutting the check ball; and
an oil passage capable of flowing oil within the retainer in the center line direction is formed between the check ball that abuts the base surface on the both sides of the local concave surface in the circumferential direction and the local concave surface.

4. The hydraulic tensioner according to claim 1, wherein the retainer has a circumferential wall provided with a plurality of oil feed ports at equal intervals in the circumferential direction centering on the center line;
the circumferential wall has an inner circumferential surface that forms a gap in the radial direction centering on the center line between the check ball seating on the seat;
the inner circumferential surface has a base surface and a plurality of local convex surfaces disposed respectively between the oil feed ports neighboring with each other in the circumferential direction and located in the radially inward direction more than the base surface;
the local convex surface is a radial restricting surface that restricts a radial moving distance of the check ball separated from the seat by abutting the check ball; and
an oil passage capable of flowing oil within the retainer in the center line direction as the oil passage is opened is formed between the check ball that abuts the convex surfaces neighboring with each other in the circumferential direction and the base surface.

5. The hydraulic tensioner according to claim 1, wherein the retainer comprises a retaining portion for retaining the ball seat, and an engaging portion that engages with the housing to stop the retainer from the housing and to radially position the retainer centering on the center line.

6. A hydraulic tensioner, comprising:
a housing having an oil supply passage;
a plunger slidable in a plunger accommodating hole in said housing and protruding from housing for applying tension to an endless, flexible transmission medium;
an oil chamber formed by the housing and the plunger; and
a check valve for permitting oil to flow from the oil supply passage into the oil chamber but limiting the flow of oil from the oil chamber to the oil supply passage;
wherein the check valve comprises:
a ball seat having a valve oil passage for flow of oil between the oil supply passage and the oil chamber and a seating surface symmetrical about a center line;
a check ball arranged to seat on said seating surface to close the valve oil passage and to separate from the seating surface to open the valve oil passage;
a retainer, arranged to be abutted by the check ball, for restricting the distance through which the check ball can separate from the seating surface; and
wherein:
the check ball is capable of seating on the seating surface and of separating from the seating surface and abutting the retainer, in response solely to a difference between the hydraulic pressures in the valve oil passage and the hydraulic pressure in the oil chamber;
the retainer has a cap wall facing the check ball along the direction of said center line;
the cap wall has a stroke restricting surface for abutment by the check ball, that restricts the distance through which check ball can move away from the seating surface in the direction of said center line;
the stroke restricting surface is a concave surface having curved cross-sections in section planes containing said center line;
the retainer limits the abutment points at which the check ball can abut the stroke-restricting surface to an abutment region on said stroke-restricting surface; and
the center of curvature of the curve at each abutment point within said abutment region is located on the same side of said stroke-restricting surface on which the seating surface of the ball seat is located, and the radial distance from any abutment point in said region, except for a set of abutment points in proximity to said center line is greater than the distance from said center of curvature to said center line.

7. The hydraulic tensioner according to claim 6, wherein the radial distance from any abutment point in said region, except for a set of abutment points within a distance from said center line equal to 10% of the radius of said check ball, is greater than the distance from said center of curvature to said center line.

8. The hydraulic tensioner according to claim 6, wherein:
the retainer has a circumferential wall centered on the center line;
the circumferential wall is provided with a plurality of oil feed ports disposed at equal circumferential intervals;
the circumferential wall has an inner circumferential surface the radial dimensions of which are such that, when the check ball is seated on the seating surface, a radial gap centered on the center line is formed between the check ball and the circumferential wall;
the inner circumferential surface includes a base surface and a plurality of local concave surfaces, each of the local concave surfaces being disposed between a pair of said oil feed ports and having a radial dimension greater than the radius of the base surface;
the base surface is capable of being abutted by the check ball when the check ball is separated from the seating surface whereby the base surface restricts radial movement of the check ball; and
when the check ball abuts the base surface on each side of one of said local concave surfaces, the check ball, with said local concave surface, forms an oil passage through which oil can flow through the retainer past the ball in a direction parallel to the center line.

9. The hydraulic tensioner according to claim 6, wherein:
the retainer has a circumferential wall centered on the center line;
the circumferential wall is provided with a plurality of oil feed ports disposed at equal circumferential intervals;
the circumferential wall has an inner circumferential surface the radial dimensions of which are such that, when the check ball is seated on the seating surface, a radial gap centered on the center line is formed between the check ball and the circumferential wall;
the inner circumferential surface has a base surface and a plurality of local surfaces, each said local surface being disposed between a pair of said oil feed ports and having a radial dimension less than the radius of the base surface;
each of said local surfaces is capable of being abutted by the check ball when the check ball is separated from the seating surface whereby said local surfaces restrict radial movement of the check ball; and
the base surface and the local surfaces are shaped so that when the check ball is in abutment with two local surfaces on opposite sides of a portion of the base surface between said two local surfaces, the check ball, with said portion of the base surface, forms an oil passage through which oil can flow through the retainer past the ball in a direction parallel to the center line.

10. The hydraulic tensioner according to claim 6, wherein the retainer comprises an engaging portion engaging the housing, said engaging portion holding the retainer both in fixed relation to the housing and in centered relationship to said center line, and said retainer also comprises a retaining portion engaging the ball seat and retaining the ball seat in fixed relation to the housing.
